(19) United States
(12) Patent Application Publication
(10) Pub. No.: US 2009/0184109 A1
(43) Pub. Date: Jul. 23, 2009

(54) Processing apparatus and process method

(75) Inventors: Ikuo Sawada, Nirasaki-Shi (JP); Hiroyuki Matsuura, Oshu-Shi (JP); Toshiki Takahashi, Oshu-shi (JP)

Correspondence Address: SMITH, GAMBRELL & RUSSELL, 1130 CONNECTICUT AVENUE, N.W., SUITE 1130, WASHINGTON, DC, 20036, US

(73) Assignee: TOKYO ELECTRON LIMITED, Tokyo-To (JP)

(21) Appl. No.: 12/320,105

(22) Filed: Jan. 16, 2009

(30) Foreign Application Priority Data
Jan. 22, 2008 (JP) 2008-012000

(51) Int. Cl. H05B 6/10; H05B 6/22

(52) U.S. Cl. 219/643; 219/647

(57) ABSTRACT

A processing apparatus subjects an object to be processed W to a heat process. The processing apparatus comprises: a processing vessel 22 capable of containing a object to be processed W; a coil part for induction heating 104 that is disposed outside the processing vessel 22; a radiofrequency power source 110 configured to apply a radiofrequency power to the coil part for induction heating 104; a gas supply part 90 configured to introduce a gas into the processing vessel 22; a holding part 24 configured to hold the object to be processed W in the processing vessel 22; and a induction heating element N that is inductively heated by a radiofrequency from the coil part for induction heating 104 so as to heat the object to be processed W. The induction heating element N is provided with a cut groove for controlling a flow of an eddy current generated on the induction heating element.

### CROSS REFERENCE TO RELATED APPLICATIONS

This application is based upon and claims the benefit of priority from the prior Japanese Patent Application No. 2008-012000 filed on Jan. 22, 2008, the entire contents of which are incorporated herein by reference.

### FIELD OF THE INVENTION

The present invention relates to a processing apparatus and a processing method that perform various heat processes such as a film deposition process for depositing a thin film on a surface of an object to be processed such as a semiconductor wafer.

### BACKGROUND ART

In order to manufacture a semiconductor integrated circuit, various heat processes, such as a film deposition process, an etching process, an oxidation process, a diffusion process, and a modification process, are generally performed to a semiconductor wafer formed of a silicon substrate or the like. For example, a film deposition process among these various heat processes is performed in, e.g., a batch-type film deposition apparatus disclosed in JP8-44286A, JP9-246257A, 2002-9009A, JP2006-54432A, JP2006-287194A, and so on. To be specific, as shown in FIG. 20, a wafer boat 4 supporting semiconductor wafers W as objects to be processed in a tier-like manner is loaded into a vertical quartz processing vessel 2, and the wafers W are heated at a predetermined temperature such as from about 600° C. to about 700° C., by a cylindrical heating means 6 disposed to surround the processing vessel 2.

Then, while various required gases, e.g., film deposition gases when a film deposition process is performed, are being supplied from a gas supply part 8 into the processing vessel 2 through a lower part thereof, an inside of the processing vessel 2 is vacuumized by a vacuum exhaust system 12 through an exhaust port 10 formed in a ceiling part of the processing vessel 2, and the inside atmosphere is maintained at a predetermined pressure. Under this state, various heat processes such as film deposition processes are performed.

In the aforementioned conventional processing apparatus, since the wafers W in the processing vessel 2 are heated by the heating means 6 surrounding the processing vessel 2 by a Joule heat, the quartz processing vessel 2 having a relatively high heat capacity has to be inevitably heated. Thus, there is a problem in that an energy consumption is considerably increased for heating the processing vessel 2.

In addition, since the processing vessel 2 itself is exposed to a high temperature, when a film deposition process is performed, for example, unnecessary adhesive coats are likely to deposit not only on the surfaces of the wafers W of a high temperature but also on an inside wall surface of the processing vessel 2 heated at a high temperature. Thus, there are other problems in that the unnecessary adhesive coats cause particles, and that a cleaning cycle is shortened because of the unnecessary adhesive coats.

In addition, when a wafer W is thermally processed, it is required that a temperature of the wafer W is rapidly increased and decreased in order to prevent unnecessary diffusion of a dopant due to miniaturization of a junction or the like of a semiconductor element. However, as described above, when a temperature of the wafer W is increased and decreased, a temperature of the processing vessel 2 having a high heat capacity should be simultaneously increased and decreased. Thus, there is a further problem in that it is significantly difficult to rapidly increase and decrease the temperature of the wafer W.

### DISCLOSURE OF THE INVENTION

In view of the above problems, the present invention has been made to effectively solve the same. The object of the present invention is to provide a processing apparatus and a processing method capable of heating an object to be processed without heating a processing vessel itself with the use of induction heating, whereby an energy consumption can be saved, an unnecessary adhesive coat or the like can be prevented from being deposited on an inner surface of the processing vessel, and a temperature of the object to be processed can be rapidly increased and decreased.

A processing apparatus in a first aspect of the present invention is a processing apparatus for subjecting an object to be processed to a heat process, the processing apparatus comprising:

a processing vessel capable of containing a object to be processed;

a coil part for induction heating that is disposed outside the processing vessel;

a radiofrequency power source configured to apply a radiofrequency power to the coil part for induction heating;

a gas supply part configured to introduce a gas into the processing vessel;

a holding part configured to hold the object to be processed in the processing vessel; and

a induction heating element that is inductively heated by a radiofrequency from the coil part for induction heating so as to heat the object to be processed;

wherein the induction heating element is provided with a cut groove for controlling a flow of an eddy current generated on the induction heating element.

In the processing apparatus in the first aspect of the present invention, it is preferable that the coil part for induction heating is wound around an outer circumference of the processing vessel.

In the processing apparatus in the first aspect of the present invention, it is preferable that the induction heating element is held by the holding part.

In such a processing apparatus, it is preferable that the holding part can be loaded into and unloaded from the processing vessel, with holding the object to be processed and the induction heating element.

In the aforementioned processing apparatus, it is preferable that

the object to be processed includes a plurality of objects to be processed,

the induction heating element includes a plurality of induction heating elements, and

the holding part holds the objects to be processed and the induction heating elements such that the objects to be processed and the induction heating elements are alternately positioned.

In the processing apparatus in the first aspect of the present invention, it is preferable that

the coil part for induction heating includes a metal pipe, and

the metal pipe is connected to a cooler that flows a coolant through the metal pipe.

In the processing apparatus in the first aspect of the present invention, it is preferable that

the object to be processed has a discoid shape, and

the induction heating element has a discoid shape whose diameter is larger than a diameter of the object to be processed.

In the processing apparatus in the first aspect of the present invention, it is preferable that the object to be processed and the induction heating element can be brought close to each other.

In the processing apparatus in the first aspect of the present invention, it is preferable that

the induction heating element has a flat shape, and

the groove is formed from an edge of the induction heating element toward a central part of the induction heating element.

In such a processing apparatus, it is preferable that the groove includes a plurality of grooves that are arranged in a circumferential direction of the induction heating element at equal intervals therebetween.

In such a processing apparatus, it is preferable that

the grooves are divided into a plurality of groups depending on lengths, and

the respective grooves in the same group are arranged in the circumferential direction of the induction heating element at equal intervals therebetween.

In the processing apparatus in the first aspect of the present invention, it is preferable that a small hole for preventing cracking caused by a thermal stress is formed on an end of the groove.

A processing apparatus in a second aspect of the present invention is a processing apparatus for subjecting an object to be processed to a heat process, the processing apparatus comprising:

a processing vessel capable of containing the object to be processed;

a coil part for induction heating that is disposed outside the processing vessel;

a radiofrequency power source configured to apply a radiofrequency power to the coil part for induction heating;

a gas supply part configured to introduce a gas into the processing vessel;

a holding part configured to hold the object to be processed in the processing vessel; and

a induction heating element that is inductively heated by a radiofrequency from the coil part for induction heating so as to heat the object to be processed;

wherein the induction heating element is divided into pieces.

In the processing apparatus in the first aspect or the second aspect of the present invention, it is preferable that an electrical conductivity of the induction heating element is within a range between 200 S/m and 20000 S/m.

In the processing apparatus in the first aspect or the second aspect of the present invention, it is preferable that a soaking plate is joined to, at least, a surface of the induction heating element, the surface being opposed to the object to be processed.

In such a processing apparatus, it is preferable that the soaking plate is made of a material having an electrical conductivity lower than an electrical conductivity of the induction heating element, and a thermal conductivity higher than a thermal conductivity of the induction heating element.

In such a processing apparatus, it is preferable that the soaking plate is made of one or more materials selected from the group consisting of silicon, aluminum nitride (AlN), alumina (Al₂O₃), and SiC.

In the processing apparatus in the first aspect or the second aspect of the present invention, it is preferable that the induction heating element is made of one or more materials selected from the group consisting of conductive ceramic, graphite, glassy carbon, conductive quartz, and conductive silicon.

A processing method in a first aspect of the present invention is a processing method for subjecting an object to be processed to a heat process, the processing method comprising:

a step in which a holding part is inserted into a processing vessel, the holding part holding the object to be processed and induction heating element which is provided with a cut groove; and

a step in which a gas is introduced into the processing vessel, and the induction heating element is inductively heated by applying thereto a radiofrequency from a coil part for induction heating wound around an outer circumference of the processing vessel, whereby the object to be processed is heated so as to be thermally processed by the thus heated induction heating element;

wherein a flow of an eddy current generated on the induction heating element inductively heated is controlled by the cut groove provided in the induction heating element.

In the processing method in the first aspect of the present invention, it is preferable that

the object to be processed includes a plurality of objects to be processed,

the induction heating element includes a plurality of induction heating elements, and

the holding part holds the objects to be processed and the induction heating elements such that the objects to be processed and the induction heating elements are alternately positioned.

The processing method in the first aspect of the present invention preferably further comprises a step in which the object to be processed and the induction heating element are brought close to each other or away from each other.

A processing method in a second aspect of the present invention is a processing method for subjecting an object to be processed to a heat process, the processing method comprising:

a step in which the object to be processed that is held by a holding part is inserted into a processing vessel in which induction heating element which is provided with a cut groove is contained; and

a step in which a gas is introduced into the processing vessel, and the induction heating element is inductively heated by applying thereto a radiofrequency from a coil part for induction heating wound around an outer circumference of the processing vessel, whereby the object to be processed is heated so as to be thermally processed by the thus heated induction heating element;

wherein a flow of an eddy current generated on the induction heating element inductively heated is controlled by the cut groove provided in the induction heating element.

According to the processing apparatus and the processing method of the present invention, the following excellent effect can be provided.

The induction heating element contained in the processing vessel can be inductively heated by a radiofrequency from the coil part for induction heating disposed outside the processing vessel, and the object to be processed can be heated by bringing the object to be processed close to the thus inductively heated induction heating element.

Accordingly, as described above, an object to be processed can be heated without heating a processing vessel itself with the use of induction heating, whereby an energy consumption can be saved, an unnecessary adhesive coat or the like is prevented from being deposited on an inner surface of the processing vessel, and a temperature of the object to be processed can be rapidly increased and decreased.

Furthermore, since the induction heating element is provided with the cut groove for controlling a flow of an eddy current generated on the induction heating element, the eddy current can flow over all the surface of the induction heating element. Thus, it is possible to improve an in-plane-temperature uniformity of the object to be processed that is heated by the induction heating element.

### BRIEF DESCRIPTION OF THE DRAWINGS

FIG. 1 is a structural view showing a processing apparatus in a first embodiment of the present invention.

FIG. 2 is a sectional view showing a processing vessel.

FIG. 3 is an operational explanatory view showing an operation of a holding part for supporting objects to be processed and an induction heating element.

FIG. 4 is an enlarged sectional view showing a rotational mechanism at a lower end of the processing vessel.

FIG. 5 is a graph showing a simulation result about a distribution of an eddy current of a discoid induction heating element.

FIG. 6 is a graph showing a current density ratio and a frequency dependency of glassy carbon.

FIG. 7 is a graph showing a current density ratio and a frequency dependency of conductive SiC.

FIG. 8 is a sectional view showing an alternative example of the induction heating element.

FIG. 9 is a partial structural view showing an alternative example of the holding part.

FIG. 10 is a plan view showing a shape of the induction heating element.

FIG. 11 is a side view of the induction heating element to which soaking plates are joined.

FIG. 12 is a plan view showing the induction heating element divided into a plurality of pieces.

FIG. 13 is a side view of the induction heating element divided into a plurality of pieces to which a soaking plate is joined.

FIG. 14 is a view showing a simulation result of induction heating by the induction heating element.

FIG. 15 is a perspective view showing a processing apparatus in a second embodiment of the present invention.

FIG. 16 is a schematic view showing an appearance of the processing apparatus in the second embodiment.

FIG. 17 is an enlarged structural view showing the processing apparatus in the second embodiment.

FIG. 18 is a plan view showing a placing table as a holding part for an object to be processed.

FIG. 19 is an enlarged view showing a placing table of a processing apparatus of a single-wafer type to which the present invention is applied.

FIG. 20 is a structural view showing an example of a conventional processing apparatus.

### MODES FOR CARRYING OUT THE INVENTION

A suitable embodiment of a processing apparatus and a processing method of the present invention will be described herebelow with reference to the accompanying drawings.

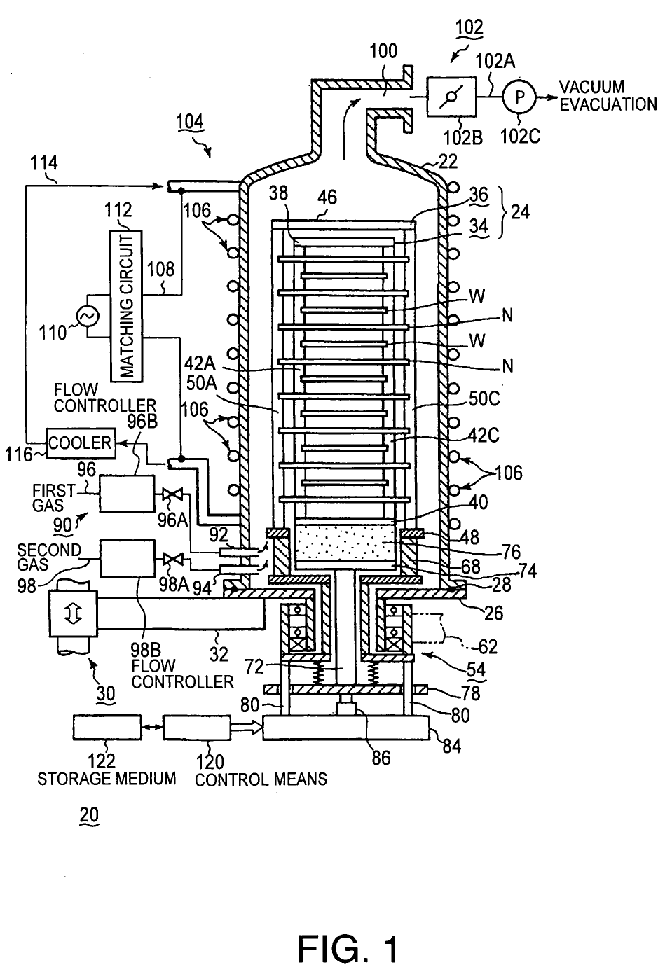

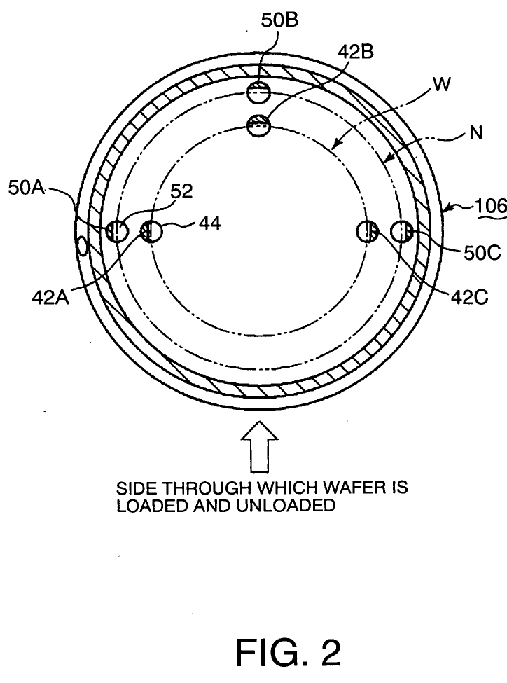

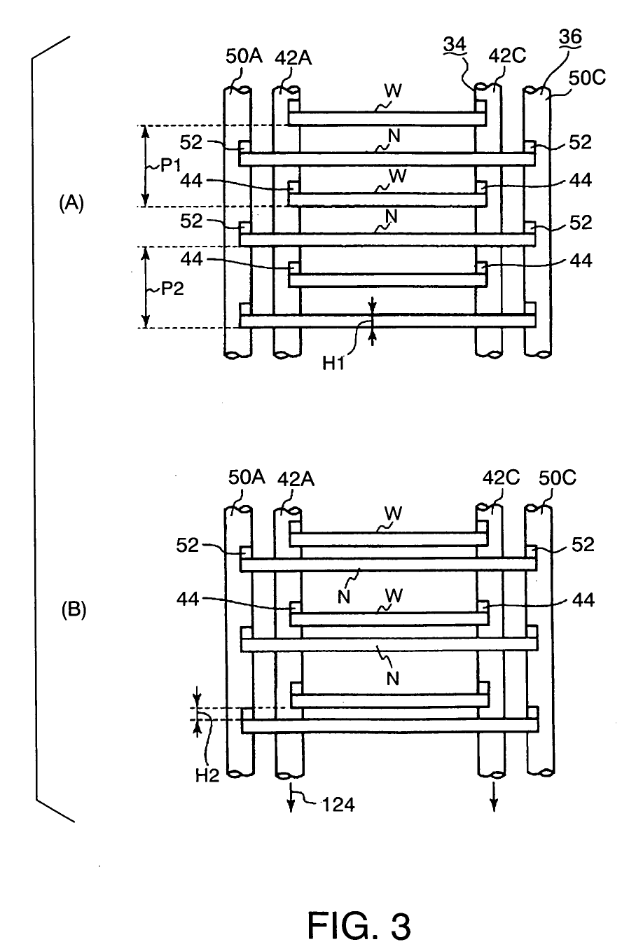

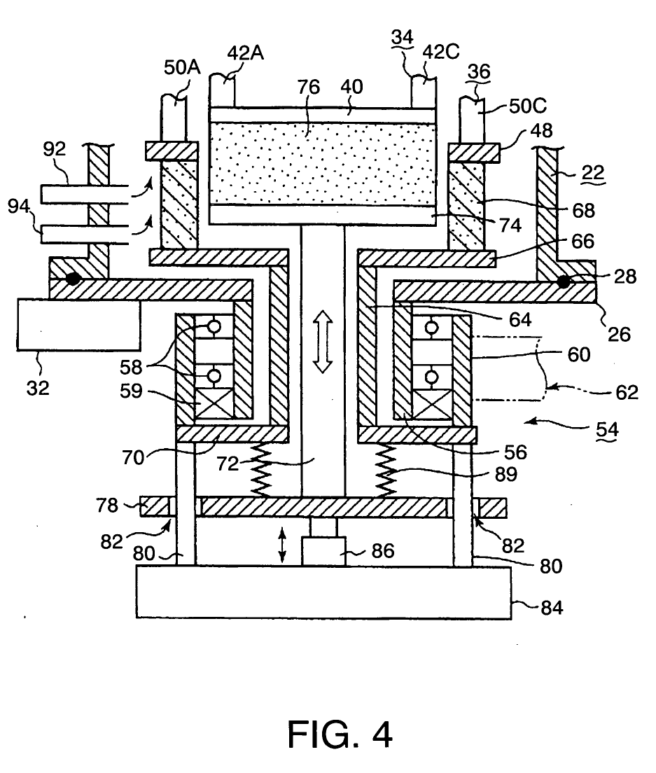

FIG. 1 is a structural view showing a processing apparatus in a first embodiment of the present invention. FIG. 2 is a sectional view showing a processing vessel. FIG. 3 is an operational explanatory view showing an operation of a holding part for supporting objects to be processed and an induction heating element. FIG. 4 is an enlarged sectional view showing a rotational mechanism at a lower end of the processing vessel. Given herein as an example to describe a heat process is a film deposition process.

As shown in FIG. 1, the processing apparatus 20 includes a vertical processing vessel 22 having an opened lower end, the processing vessel 22 being formed to have a cylindrical shape of a predetermined length in an up and down direction (vertical direction). The processing vessel 22 is made of, e.g., quartz having a high heat resistance.

A holding part 24 can be vertically loaded into and unloaded from the processing vessel 22 through a lower end opening thereof, the holding part 24 holding a plurality of discoid semiconductor wafers W as objects to be processed, and a plurality of induction heating elements N that are respectively arranged at predetermined pitches in a tier-like manner. After the holding part 24 has been inserted into the processing vessel 22, the lower end opening of the processing vessel 22 is closed by a lid member 26 formed of a quartz plate or a stainless plate, so that the processing vessel 22 is air-tightly sealed. In order to maintain the air-tightly sealed state, a sealing member 28 such as an O-ring is interposed between a lower end of the processing vessel 22 and the lid member 26. The lid member 26 and the holding part 24 as a whole are supported on an end of an arm 32 disposed on an elevating mechanism 30 such as a boat elevator, so that the holding part 24 and the lid member 26 can be elevated and lowered together with each other.

In this embodiment, the holding part 24 has a first holding boat (first holding part) 34 configured to hold the semiconductor wafers W, and a second holding boat (second holding part) 36 configured to hold the induction heating elements N. Specifically, the overall first holding boat 34 is made of, e.g., quartz which is a heat resistive material. The first holding boat 34 is composed of a top plate 38 having a circular ring shape, a bottom plate 40 having a circular ring shape, and three columns 42A, 42B, and 42C, as shown in FIG. 2 connecting the top plate 38 and the bottom plate 40 to each other (only two columns are shown in FIG. 1).

As shown in FIG. 2, the three columns 42A to 42C are arranged along a semi-circular arc in a plane at equal intervals therebetween. Wafers W can be loaded and unloaded by a fork (not shown) for holding wafers W through a side opposed to the semi-circular arc. As shown in FIG. 3, the respective columns 42A to 42C are longitudinally provided in their inner sides with stepped grooves 44 for holding edges of wafers W at equal pitches. Thus, a plurality of, e.g., between about 10 and about 55 wafers W can be supported at equal pitches in a tier-like manner, with edges of the wafers W being supported on the respective grooves 44.

On the other hand, the second holding boat 36 is formed larger than the first support boat 34 in a planar direction, and is disposed to surround the first holding boat 34. The second holding boat 36 is formed similarly to the first holding boat 34. Namely, the overall second holding boat 36 is made of, e.g., quartz which is a heat resistive material. The second holding boat 36 is composed of a top plate 46 having a circular ring shape, a bottom plate 48 having a circular ring shape, and three columns 50A, 50B, and 50C, as shown in FIG. 2 connecting the top plate 46 and the bottom plate 48 to each other (only two columns are shown in FIG. 1).

As shown in FIG. 2, the three columns 50A to 50C are arranged along a semi-circular arc in a plane at equal intervals therebetween. Induction heating elements N can be loaded and unloaded by a fork (not shown) for holding induction heating element N through a side opposed to the semi-circular arc. As shown in FIG. 3, the respective columns 50A to 50C are longitudinally provided in their inner sides with stepped grooves 52 for holding edges of induction hating elements N at equal pitches. Thus, a plurality of, e.g., between about 15 and about 60 induction heating elements N can be supported at equal pitches in a tier-like manner, with edges of the induction heating elements N being supported on the respective grooves 52.

The induction heating element N is capable of causing induction heating by a radiofrequency, and can be made of a material excellent in heat conductivity such as a conductive ceramic material such as SiC. The induction heating element N has a discoid shape similar to a shape of the semiconductor wafer W, but has a diameter larger than a diameter of the wafer W. For example, when the diameter of the wafer W is 300 mm, the diameter of the induction heating element N is set to be from about 320 mm to about 340 mm. As described below, it is preferable that the induction heating element N has a cut groove for controlling a flow of an eddy current generated on the induction heating element N.

FIG. 3(A) shows a positional relationship when the wafers W are loaded and unloaded. In FIG. 3(A), the wafers W and the induction heating elements N are alternately positioned. Gaps between the certain wafer W and the induction heating elements N vertically adjacent thereto are set substantially equal to each other, so as to facilitate a loading and unloading operation of the wafers W by the fork. A pitch P1 between the wafers W and a pitch P2 between the induction heating elements N are from about 30 mm to about 40 mm, respectively. A thickness H1 of the induction heating element N is from about 2 mm to about 10 mm. The wafers W and the induction heating elements N are alternately positioned such that the induction heating elements N are located at an uppermost end position and a lowermost end position, in order that thermal conditions of the uppermost wafer W and the lowermost wafer W are identical to thermal conditions of the wafers W located on other positions.

The holding part 24 is configured to be rotatable by a rotational mechanism 54 disposed on the lid member 26 at the lower end, and the first holding boat 34 and the second holding boat 36 are configured to be relatively movable with each other in the up and down direction. To be specific, as shown in FIG. 4, the rotational mechanism 54 has a cylindrical fixed sleeve 56 extending downward from a central part of the lid member 26. An inside of the fixed sleeve 56 is communicated with an inside of the processing vessel 22. A cylindrical rotational member 60 is rotatably disposed on an outer circumference of the fixed sleeve 56 through a bearing 58. A driving belt 62 driven by a not shown driving source is wound around the rotational member 60, so that the rotational member 60 can be rotated.

Below the bearing 58, a magnetic fluid seal 59 is interposed between the fixed sleeve 56 and the rotational member 60 so as to maintain air-tightness in the processing vessel 22. A cylindrical hollow rotational shaft 64 is inserted into the fixed sleeve 56 with a slight gap therebetween. Secured on an upper end of the hollow rotational shaft 64 is a rotational table 66 having a central opening. The second holding boat 36 can be supported, by placing the bottom plate 48 of the second holding boat 36 on the rotational table 66 via, e.g., a cylindrical quartz heat retention tube 68.

A lower end of the hollow rotational shaft 64 is connected to a lower end of the rotational member 60 via a connection member 70, so that the hollow rotational shaft 64 can be rotated together with the rotational member 60. In addition, a columnar central rotational shaft 72 is inserted into the hollow rotational shaft 64 with a slight gap therebetween. Secured on an upper end of the central rotational shaft 72 is a rotational table 74. The first holding boat 34 can be supported, by placing the bottom plate 40 of the first holding boat 34 on the rotational table 74 via, e.g., cylindrical quartz heat retention tube 76. A lower end of the central rotational shaft 72 is connected to an elevation driving plate 78.

A plurality of guide rods 80 are extended downward from the rotational member 60. The guide rods 80 are inserted into guide holes 82 formed in the elevation driving plate 78. A lower end of each of the guide rods 80 is securely connected to a base plate 84. Disposed on a central part of the base plate 84 is an actuator 86 such as an air cylinder, whereby the elevation driving plate 78 can be vertically moved by a predetermined stroke. Thus, by driving the actuator 86, the first holding boat 34 can be moved downward and upward together with the central rotational shaft 72 and so on. The stroke amount is from about 20 mm to about 30 mm. As long as the first holding boat 34 and the second holding boat 36 can be relatively moved with each other in the up and down direction, it is possible to vertically move the second holding boat 36 in place of the first holding boat 34.

In this manner, by vertically moving the first holding boat 34, the induction heating element N can be brought close to the rear surface of the wafer W, as show in FIG. 3(B). At this time, a gap H2 between the wafer W and the induction heating element N is from about 2 mm to about 16 mm. An extendable bellows 89 is disposed between the elevation driving plate 78 and the connection member 70 such that the bellows 89 surround the central rotational shaft 72. Thus, the vertical movement of the central rotational shaft 72 is allowed, while the air-tightness in the processing vessel 22 is maintained.

Returning to FIG. 1, disposed on a lower part of the processing vessel 22 is a gas supply part 90 configured to supply a gas required for a heat process into the processing vessel 22. Specifically, the gas supply part 90 includes a first gas nozzle 92 and a second gas nozzle 94 which pass through a side surface of the processing vessel 22. The first and second gas nozzles 92 and 94 are made of, e.g., quartz. Gas channels 96 and 98 are connected to the gas nozzles 92 and 94, respectively. The gas channels 96 and 98 are respectively equipped with opening/closing valves 96A and 98A and flow-rate control devices such as massflow controllers 96B and 98B, whereby a first gas and a second gas required for a film deposition can be introduced, while flow rates thereof being controlled. Naturally, another kind of gas and a gas nozzle therefor can be added according to need.

Further, disposed on a ceiling part of the processing vessel 22 is an exhaust port 100 that is laterally bent into an L-shape. An exhaust system 102 for exhausting the processing vessel 22 is connected to the exhaust port 100. To be specific, an exhaust channel 102A of the exhaust system 102 is equipped with a pressure control valve 102B such as a butterfly valve and an exhaust pump 102C. Depending on a kind of a process, the process may be performed at a low pressure such as a vacuum state or at an atmospheric pressure. Thus, correspondingly thereto, a pressure in the processing vessel 22 can be controlled from a pressure such as a high vacuum to a pressure near an atmospheric pressure.

The processing vessel 22 is provided with a coil part for induction heating 104 which is a feature of the present invention. Specifically, the coil part for induction heating 104 includes a metal pipe 106 wound around an outer circumference of the processing vessel 22. The metal pipe 106 is helically wound around the outer circumference of the processing vessel 22 in the up and down direction. A winding area of the metal pipe 106 in a height direction is vertically extended longer than an area in which the wafers W are contained. As shown in FIG. 1, the metal pipe 106 may be wound such that vertically slight gaps are formed between the parts of the metal pipe 106. Alternatively, the metal pipe 106 may be wound such that no such gap is formed. For example, a copper pipe may be used as the metal pipe 106.

A feeder line 108 is connected to upper and lower opposed ends of the metal pipe 106. An end of the feeder line 108 is connected to a radiofrequency power source 110, so that a radiofrequency power can be applied to the metal pipe 106. A matching circuit 112 for matching impedance is disposed on the feeder line 108.

As described above, by applying a radiofrequency power to the coil part for induction heating 104 formed of the metal pipe 106, a radiofrequency radiated from the coil part for induction heating 104 passes through the sidewall of the processing vessel 22 and reaches the inside thereof, whereby an eddy current is generated on the induction heating elements N supported by the second holding boat 36 so that the induction heating elements N are heated. A frequency of a radiofrequency generated by the radiofrequency power source 110 is set with a range between, for example, 0.5 kHz and 50 kHz, preferably between 1 kHz and 5 kHz.

When a frequency is smaller than 0.5 kHz, induction heating cannot be effectively performed. On the other hand, when a frequency is larger than 50 kHz, a skin effect becomes so large that only a peripheral part of the induction heating element N is heated, resulting in a significantly impaired in-plane temperature uniformity of the wafer W.

Extended from the opposed ends of the metal pipe 106 is a medium channel 114. A cooler 116 is connected to the medium channel 114. Thus, a coolant can be flown through the metal pipe 106 so as to cool the same. A cooling water may be used as the coolant.

An operation of the apparatus is controlled as a whole by a control means 120 formed of, e.g., a computer. The control means 120 has a storage medium 122 storing a program for controlling an operation of the apparatus as a whole. The storage medium 122 is formed of, for example, a flexible disc, a CD (Compact Disc), a CD-ROM, a hard disc, a flash memory, or a DVD.

Next, a film deposition method (heat process) performed by using the processing apparatus 20 as structured above is described. As described above, the operation explained below is performed based on the program stored in the storage medium 122.

At first, the holding part 24 including the first holding boat 34 and the second holding boat 36 is lowered and unloaded from the processing vessel 22. Under this state, unprocessed wafers W are transferred to the first holding boat 34 of the holding part 24 by using a transfer fork, not shown, such that the wafer W are held by the first holding boat 34.

FIG. 3(A) shows a vertical positional relationship of the first and the second holding boats 34 and 36 at this time. Namely, gaps between the certain wafer W and the induction heating elements N vertically adjacent thereto are wide to thereby facilitate the transfer of the wafers W. The induction heating elements N have been sent to the second holding boat 36 by a not-shown fork beforehand so as to be supported by the same. The induction heating elements N are continuously supported over, e.g., a plurality of batch processes of wafers. Cleaning of the induction heating elements N is performed simultaneously when the inside of the processing vessel 22 is dry-cleaned, for example.

After the transfer of the wafers W has been completed, and the wafers W and the induction heating elements N have been alternately positioned as shown in FIG. 3(A), the holding part 24 is elevated by driving the elevating mechanism 30 so as to load the holding part 24 into the processing vessel 22 through the lower end opening of the processing vessel 22. Then, the lower end opening of the processing vessel 22 is air-tightly sealed by the lid member 26, so that the inside of the processing vessel 22 is hermetically sealed.

Then, by driving the actuator 86 disposed on the rotational mechanism 54 below the holding part 24, the elevation driving plate 78 and the central rotational shaft 72 (see FIG. 4) connected thereto are lowered by a predetermined stroke. Namely, as shown an arrow 124 in FIG. 3(B), the first holding boat 34, which is placed on the rotational table 74 on the upper end of the central rotational shaft 72 via the heat retention tube 76, is lowered by the predetermined stroke. Thus, as shown in FIG. 3(B), each of the wafers W is brought close to the upper surface of the induction heating element N downwardly adjacent to the wafer W, whereby the wafer W can effectively receive a radiant heat or the like from the induction heating element N.

After the state shown in FIG. 3(B) has been realized, the radiofrequency power source 100 is switched on to thereby apply a radiofrequency power to the coil part for induction heating 104 formed of the metal pipe 106. Thus, a radiofrequency is radiated into the processing vessel 22, whereby an eddy current is generated on the respective induction heating elements N supported by the second holding boat 36 whereby the induction heating elements N are inductively heated.

When the respective induction heating elements N are inductively heated, the respective wafers W positioned near the same are heated by a radiant heat or the like from the induction heating elements N and temperatures of the wafers W are increased. At the same time, while gases required for a film deposition, i.e., the first and the second gases are supplied from the gas nozzles 92 and 94 of the gas supply part 90, with the flow rates of the gases being controlled, an atmosphere inside the processing vessel 22 is vacuumized by the exhaust system 102 through the exhaust port 100 on the ceiling part, and the in-vessel atmosphere is maintained at a predetermined process pressure.

In addition, while measuring the temperatures of the wafer W by a thermocouple, not shown, disposed in the processing vessel 22, the temperatures of the wafers W are maintained at a predetermined process temperature by controlling the radiofrequency power. Under this state, a predetermined heat process, namely, a film deposition process is performed. The process is performed by driving the rotational mechanism 54 disposed on the lid member 26 so as to rotate the first and the second boats 34 and 36 at a predetermined rotational speed. During the heat process, since the metal pipe 106 constituting the coil part for induction heating 104 is heated, a coolant such as a cooling water flown through the metal pipe 106 from the cooler 116 in order that the metal pipe 106 is cooled. In this case, depending on reaction conditions of the film deposition gases, the wall surface of the processing vessel 22 is preferably cooled at a temperature not more than 80° C. in order to prevent adhesion of a film to the inner wall surface.

In this manner, the induction heating elements N are inductively heated by a radiofrequency, and the wafers W near the induction heating elements N are heated by the heat radiated therefrom. Thus, an energy consumption can be reduced because the processing vessel 22 itself having a high heat capacity is not virtually heated.

As described above, since the processing vessel 22 itself is not virtually heated and is maintained at a lower temperature, deposition of an unnecessary adhesive coat on the inner wall surface of the processing vessel 22 can be prevented, particularly in the case of the film deposition process. Thus, generation of particles can be restrained, and a cleaning frequency can be decreased.

Furthermore, since the processing vessel 22 itself is not virtually heated, the temperature of the wafer W can be rapidly increased when the process is started, and the temperature of the wafer W can be rapidly decreased after the process is finished. To be specific, there are achieved a temperature increasing speed of about 0.6° C./sec for the induction heating element N, and a temperature increasing speed of about 4.0° C./sec for the wafer W.

Further, a conductive ceramic material such as conductive SiC, which is a material having a relatively lower resistance and a relatively excellent thermal conductivity, is used for the induction heating element N. Thus, the induction heating element N can be effectively, inductively heated, with an excellent in-plane temperature uniformity. Therefore, the wafer W positioned near the induction heating element N can be heated with an excellent in-plane temperature uniformity.

As described above, according to the present invention, the induction heating element N received in the processing vessel 22 is inductively heated by a radiofrequency from the coil part for induction heating 104 wound around the outer circumference of the processing vessel 22. Thus, it is possible to heat an object to be processed, such as the wafer W, which is positioned near the induction heating element N that is inductively heated.

Thus, as described above, due to the induction heating, the object to be processed can be heated without heating the processing vessel 22 itself. As a result, an energy consumption can be saved, an unnecessary adhesive coat or the like can be prevented from being deposited on the inner surface of the processing vessel, and a temperature of the object to be processed can be rapidly increased and decreased.

<Evaluation of Eligibility as Induction Heating Element>

The eligibility as the induction heating element N for heating the semiconductor wafer W was examined. The evaluation result is described below.

The feature required for the induction heating element N is to effectively, inductively heat the semiconductor wafer W by a radiofrequency. In addition, the induction heating element N is required to have a high thermal conductivity, and to uniformly heat the semiconductor wafer W as much as possible in an in-planar direction. As is commonly known, when a conductive object is inductively heated by a radiofrequency, heat is generated by a generated eddy current. In terms of exponential function, the eddy current in the conductive object becomes larger as the eddy current is positioned nearer to the surface of the conductive object, and the eddy current becomes smaller as the eddy current is positioned nearer to the center thereof. Thus, when a discoid conductive object is inductively heated, a peripheral part thereof is likely to be more rapidly heated than a central part thereof.

When a skin effect produced by the induction heating is observed, a current depth of penetration δ is a very important numerical value. It is desired that the current depth of penetration δ is larger as much as possible. The current depth of penetration δ is defined as a depth at which an eddy current becomes a value that is 1/e (about 0.368) times smaller than an eddy current intensity on the surface of the induction heating element. The current depth of penetration δ is shown by the following expression.

δ (cm)=5.03 (ρ/μf)^{1/2} in which:
ρ: resistance of induction heating element (μΩ·cm);
μ: relative permeability of induction heating element (μ=1 in non-magnetic element); and
f: frequency (Hz).

Note that μ=1 in SiC.

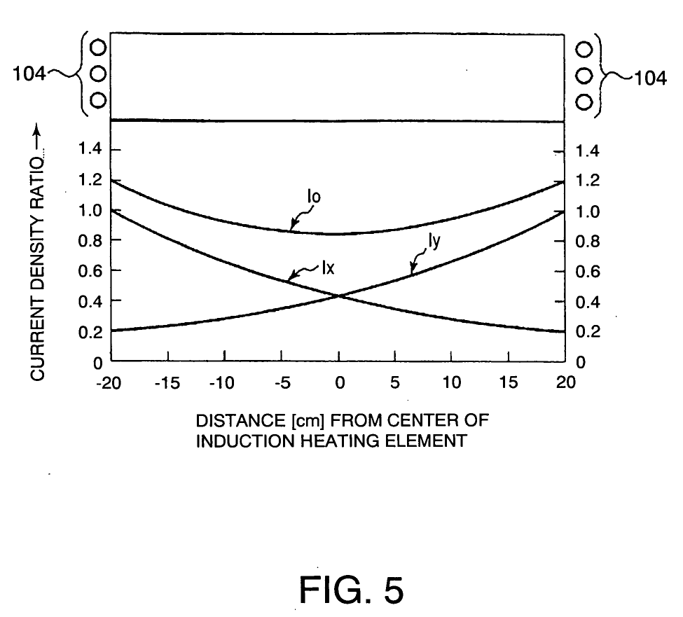

A distribution of an eddy current of the discoid induction heating element N made of the above conductive object was simulated. FIG. 5 shows the distribution of the eddy current.

In FIG. 5, the axis of abscissa shows a distance (unit is cm) from the center of the sectional surface of the induction heating element, and the axis of ordinate shows a current density ratio. The coil part for induction heating 104 is wound around the outer circumferential surface (corresponding to the right and left axes of ordinate) of the induction heating element. Herein, a current value of the peripheral part (“−20” and “+20” in distance) is used as a reference of the current density ratio.

In the graph, a curve Ix shows a distribution of a current generated by the coil part for induction heating 104 on the left side of the sectional surface, and a curve Iy shows a distribution of a current generated by the coil part for induction heating 104 on the right side of the sectional surface. A curve Io shows a current distribution of a superposition current in which the curves Ix and Iy are superposed. As understood from the curve Io, at the peripheral part of the induction heating element, the current value was larger and thus a heat value was larger. However, as the measuring point came closer to the central part, the current value, i.e., the heat value becomes gradually lowered.

Next, two kinds of material as a material for the induction heating element N were examined. Namely, there were simulated and evaluated a current density ratio and a frequency dependency of glassy carbon and conductive SiC which is a typical example of a conductive ceramic material. The evaluation result is described below.

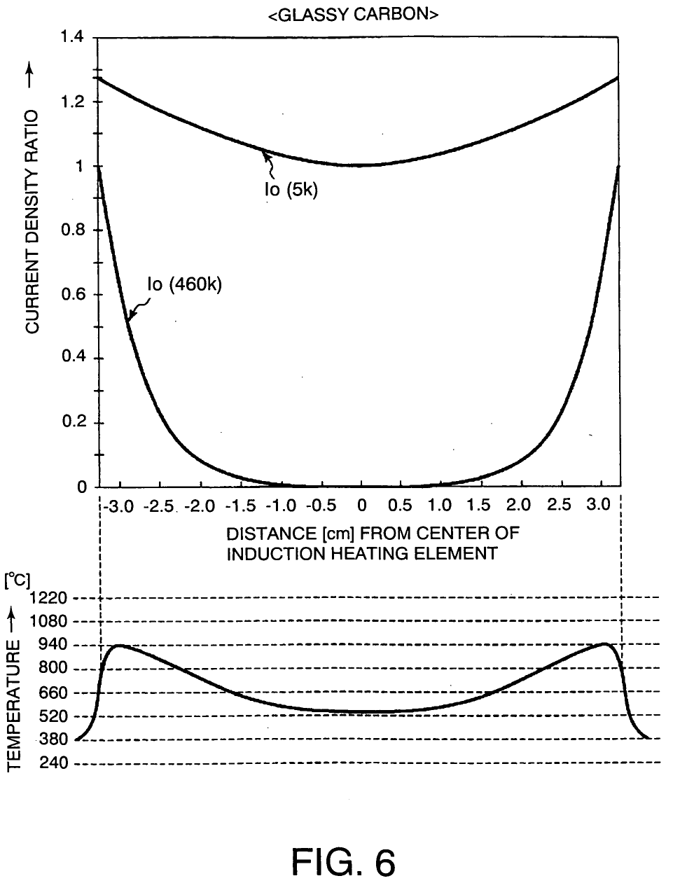

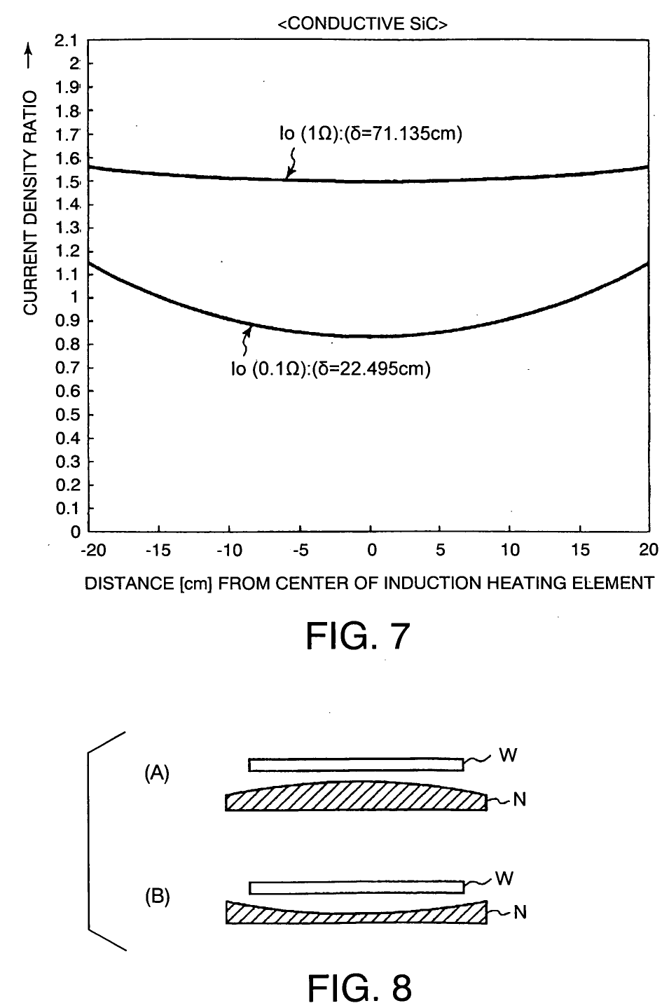

FIG. 6 is a graph showing a current density ratio and a frequency dependency of glassy carbon, and FIG. 7 is a graph showing a current density ratio and a frequency dependency of conductive SiC. This graph shows only a superposition current Io as shown in FIG. 5. Similarly to FIG. 5, the axis of abscissa of each graph shows a distance from the center of the sectional surface of the induction heating element, and the axis of ordinate shows a current density ratio.

Features of the glassy carbon induction heating element shown in FIG. 6 were as follows. The diameter was 6.4 cm, and the resistance was 0.0045 Ω·cm. Frequencies of a radiofrequency power were 460 kHz and 5 kHz. In the graph, the curve Io (460 k) shows a case in which a 460 kHz frequency was applied, and the curve Io (5 k) shows a case in which a 5 kHz frequency was applied.

As apparent from the graph, the curve Io (460 k) shows that, since a frequency of 460 kHz was excessively high, the superposition current drastically lowered as the measuring point came closer to the peripheral part of the induction heating element from the central part thereof. The superposition current became “zero” at the central part, which was undesirable. On the other hand, when a frequency of as low as 5 kHz was applied, the superposition current was declined from about 1.3 to about 1.0. Thus, it can be understood that the degree of decline could be significantly improved. The decline of this degree can be covered by optimizing a thermal conductivity of the induction heating element so as to improve an in-plane temperature uniformity.

In this case, as described above, an optimum frequency of the radiofrequency power is within a range between 0.5 kHz and 50 kHz, preferably between 1 kHz and 5 kHz. When a frequency is smaller than 0.5 kHz, the induction heating cannot be effectively performed. On the other hand, when a frequency is larger than 50 kHz, a skin effect becomes so large that only the peripheral part of the induction heating element N is heated, resulting in a significantly impaired in-plane temperature uniformity of the wafer W.

The material constituting the induction heating element N is preferred to have a larger thermal conductivity. For example, the material should have a thermal conductivity of not less than 5 W/mk, preferably, not less than 100 W/mk. When a thermal conductivity is smaller than 5 W/mk, an in-plane temperature uniformity of the induction heating element N is deteriorated, and thus an in-plane temperature uniformity of the wafer itself becomes insufficient. In the lower part of FIG. 6, there is shown an example of a distribution of the temperature in the sectional surface of the induction heating element of the curve Io (5 k). The peripheral part had a higher temperature such as about 940° C., and the central part had a temperature of about 520° C.

Features of the conductive SiC induction heating element shown in FIG. 7 were as follows. The diameter was 40 cm. Resistances were 1 Ω·cm and 0.1 Ω·cm. A frequency of a radiofrequency power was set at 5 kHz. In the graph, the curve Io (0.1Ω) shows a case in which the resistance of the induction heating element was 0.1 Ω·cm, and the curve Io (1Ω) shows a case in which the resistance of the induction heating element was 1 Ω·cm.

As apparent from the graph, the curve Io (0.1Ω) shows that a current density ratio changed within a range between about 0.9 and about 1.15 when the resistance was 0.1 Ω·cm. A current depth of penetration δ at this case was 22.495 cm. On the other hand, the curve Io (1Ω) shows that a current density ratio changed within a range between about 1.5 and about 1.6 when the resistance was 1 Ω·cm. A current depth of penetration δ at this case was 71.135 cm. Thus, it can be understood that the resistance of 1 Ω·cm is preferred, because of the uniform current density ratio which results in the uniform induction heating.

In this case, a preferable resistance is within a range between 0.001 Ω·cm and 0.5 Ω·cm. When a resistance is larger than 0.5 Ω·cm, a heat generation efficiency is severely decreased, which is undesirable. On the other hand, when a resistance is smaller than 0.001 Ω·cm, a current penetration depth is excessively reduced, which is undesirable.

In the above embodiment, the induction heating element N is brought close to the lower surface of the semiconductor wafer W (see, FIG. 3(B)), in order not to inhibit a gas flow on a side of the upper surface of the semiconductor wafer W. However, not limited thereto, by moving upward the first holding boat 34 from the state shown in FIG. 3(A), the induction heating element N may be brought close to the upper surface of the semiconductor wafer W. In addition, the second holding boat 36 in place of the first holding boat 34 may be configured to be vertically movable.

Further, in the above embodiment, the holding part 24 is rotatable. However, not limited thereto, the holding part 24 may be fixed. In addition, in the above embodiment, gases are introduced through the first and the second gas nozzles 92 and 94 to the lower part of the processing vessel 22, and the gases are discharged from the ceiling side thereof. However, not limited thereto, the gases may be introduced from the ceiling side of the processing vessel 22, and may be discharged from the lower part thereof. In addition, so-called dispersion nozzles may be used as the gas nozzles 92 and 94. In this case, the gas nozzles 92 and 94 are disposed in the processing vessel 22 along the longitudinal direction thereof, and are provided with a plurality of gas jet holes at equal intervals therebetween.

Furthermore, the shape of the processing vessel 22 is not limited to the single tube structure as shown in FIG. 1. There may be used a processing vessel of a so-called double-tube type, in which an inner tube and an outer tube, which are made of, e.g., quartz, are concentrically arranged.

In addition, in the above embodiment, the induction heating element N has a flat shape. However, not limited thereto, the sectional shape of the induction heating element N as shown in FIG. 8 is possible. Namely, the central part of the induction heating element N may have a convex shape in accordance with a temperature distribution of the wafer W (see, FIG. 8(A)), so as to make smaller a distance between the central part and the wafer W than a distance between the peripheral part and the wafer W. On the other hand, the central part of the induction heating element may have a concave shape, so as to make larger a distance between the central part and the wafer W than a distance between the peripheral part and the wafer W.

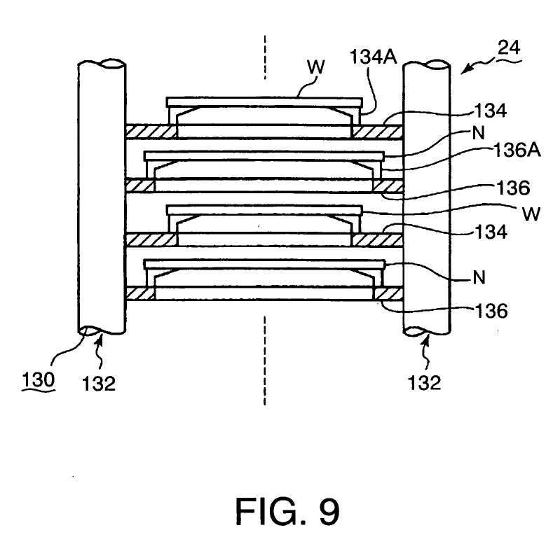

In this embodiment, the holding part 24 is composed of the two holding boats, i.e., the first and the second holding boats 34 and 36. However, not limited thereto, as shown in FIG. 9, the holding part 24 may be composed of one holding boat 130. The holding boat 130 has a structure as disclosed in JP8-44286A, for example. Specifically, quartz ring members 134 each having a circular ring shape of a smaller inner diameter and quartz ring members 136 each having a circular ring shape of a larger inner diameter are alternately joined to quartz columns 132. A claw 134A for supporting a peripheral part of a wafer W is disposed on an inner circumference of each ring member 134, and a claw 136A for supporting a peripheral part of an induction heating element N having a diameter larger than the wafer W is disposed on an inner circumference of each ring member 136.

In this case, since the wafers W and the induction heating elements N cannot be brought close to each other and away from each other, the ring members 134 and 136 and the claws 134A and 136A are previously constituted such that the wafers W and the induction heating elements N are close to each other as much as possible.

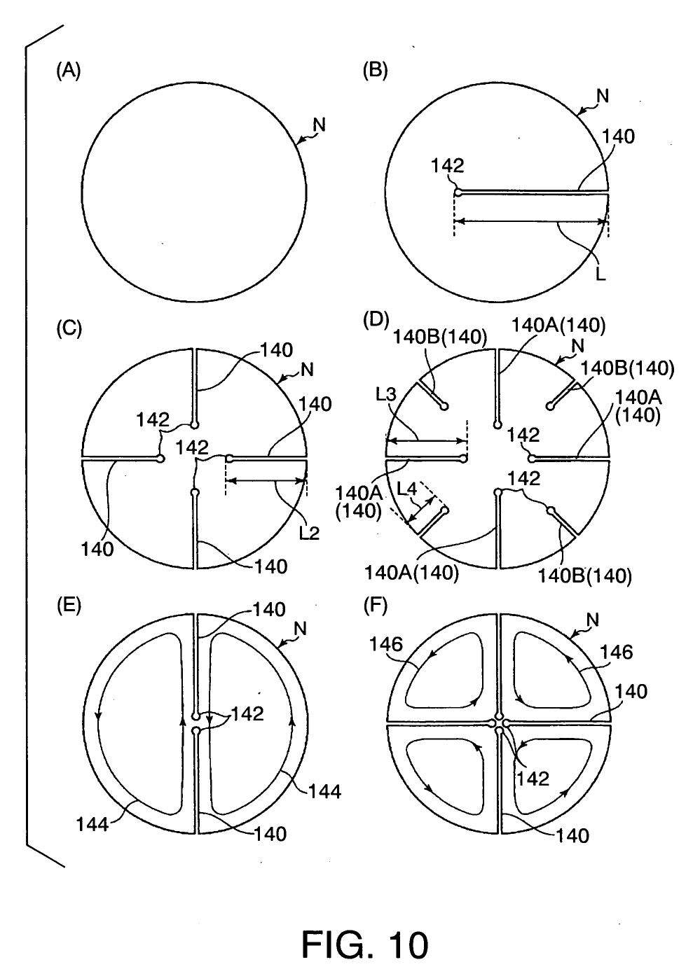

The shape of the induction heating element N is described in detail below. FIG. 10 is a plan view showing a shape of the induction heating element. The simplest structure as the shape of the induction heating element N is a circular flat shape as shown in FIG. 10(A). In this case, there is a possibility that the peripheral part (edge) is more likely to be heated but the central part thereof is insufficiently heated because of the aforementioned skin effect by a radiofrequency, which may impair an in-plane temperature uniformity of the wafer. A diameter of the induction heating element N shown in FIG. 10 is 350 mm.

Thus, as shown in FIGS. 10(B) to 10(F), it is preferable that the induction heating element N has a cut groove 140 for controlling a flow of an eddy current generated on the induction heating element N. To be specific, the groove 140 is formed in the flat (discoid) induction heating element N from the edge thereof toward the central part thereof. In a case shown in FIG. 10(B), the number of the groove 140 is one, and the groove is formed from the edge of the discoid induction heating element N to the central part thereof, with an end of the groove 140 extending through the center of the discoid induction heating element N to reach a point on the radially opposed side.

A length L1 of the groove 140 is about 233 mm. In order to prevent cracking caused by a thermal stress, the end of the groove 140 has a small hole 142 in communication with the groove 140. It is preferable to provide the small hole 142, but the small hole 142 may be omitted. A diameter of the small hole 142 is within a range between about 8 mm and about 20 mm. A width of the groove 140 is within a range between about 2 mm to about 8 mm. These numerical values hold true with the following cases.

In the case shown in FIG. 10(B), an eddy current mainly flowing along the edge of the discoid induction heating element N flows along the groove 140 toward the central part, and turns at the small hole 142 and flows to the opposed side of the groove 140.

Since an eddy current flows near the central part of the induction heating element N, a heat generation distribution can be dispersed in a planar direction. Thus, an in-plane temperature uniformity of the semiconductor wafer W can be improved. Due to the provision of the small hole 142 on the end of the groove 140, concentration of a thermal stress can be alleviated. Thus, cracking of the induction heating element N by the thermal stress can be prevented.

In a case as shown in FIG. 10(C), the number of grooves 140 is plural, specifically, four. The grooves 140 are arranged along a circumferential direction of the discoid induction heating element N at equal intervals therebetween (90-degree interval). In this case, the lengths of the respective grooves 140 are identical to each other, and are set shorter than a radius of the discoid induction heating element N. A length L2 of the groove 140 is about 120 mm. In the illustrated example, the length of the groove 140 is set about two thirds of the radius. Each of the grooves 140 has a small hole 142 similar to the above at an end thereof. Also in this case, a phenomenon similar to the case shown in FIG. 10(B) occurs, and an eddy current generated on the induction heating element N flows along the edge and opposed sides of the grooves 140 of the induction heating element N.

Since an eddy current flows near the central part of the induction heating element N, a heat generation distribution can be dispersed in the planar direction. Thus, an in-plane temperature uniformity of the semiconductor wafer W can be improved. Due to the provision of the small hole 142 on the end of each groove 140, concentration of a thermal stress can be alleviated. Thus, cracking of the induction heating element N by the thermal stress can be prevented.

In a case as shown in FIG. 10(D), the number of grooves 140 is plural, specifically, eight. The eight grooves 140 are divided into a plurality of, herein, two groups of different lengths. The lengths of the grooves 140 in the same group are set identical to each other. Namely, there are the group of the grooves 140A of a longer length, and the group of the grooves 140B of a shorter length. The grooves 140A and 140B of the respective groups are arranged along the circumferential direction of the discoid induction heating element N at equal intervals therebetween.

In the illustrated example, the longer grooves 140A and the shorter grooves 140B are circumferentially, alternately arranged at equal intervals. A length L3 of the longer groove 140A is about 120 mm, and a length L4 of the shorter groove 140B is about 55 mm. Each of the grooves 140A and 140B has a small hole 142 at an end thereof.

Also in this case, a phenomenon similar to the case shown in FIG. 10(B) occurs, and an eddy current generated on the induction heating element. N flows along the edge and opposed sides of the grooves 140A and 140B of the induction heating element N. Since an eddy current flows near the central part and the middle circumferential parts of the induction heating element N, a heat generation distribution can be dispersed in the planar direction. Thus, an in-plane temperature uniformity of the semiconductor wafer W can be improved. Due to the provision of the small hole 142 on the end of each groove 140, concentration of a thermal stress can be alleviated. Thus, cracking of the induction heating element N by the thermal stress can be prevented.

In this case, not limited to the two longer and shorter lengths, the grooves may be divided into three or more groups of different lengths, and the grooves may be circumferentially equally arranged. For example, when grooves of three kinds of lengths, i.e., long grooves, middle grooves, and short grooves are formed, the grooves are arranged along the circumferential direction of the discoid induction heating element N in the order of the long groove, the short groove, the middle groove, the short groove, the long groove, the short groove, the middle groove, the short groove, the long groove . . . .

In a case as shown in FIG. 10(E), two grooves 140 are formed in a diametrical direction, with ends thereof being positioned near the central part of the discoid induction heating element N. Each end has a small hole 142. In this case, a spacing of a slight length remains between the ends of the grooves 140. The remaining length of the spacing is set such that the induction heating element N does not easily crack.

In this case, a current flowing into the central part of the discoid induction heating element N and a current outflowing therefrom are balanced out. As a result, the induction heating element N is electrically divided into a pair of right and left blocks, with the grooves 140 serving as boundaries. Thus, eddy currents independently flow in directions shown by arrows 144 in the right and the left blocks. Accordingly, the eddy currents flow not only near the edge of the induction heating element N but also near the central part thereof.

Since an eddy current flows near the central part of the induction heating element N, a heat generation distribution can be dispersed in the planar direction. Thus, an in-plane temperature uniformity of the semiconductor wafer W can be improved. Due to the provision of the small hole 142 on the end of each groove 140, concentration of a thermal stress can be alleviated. Thus, cracking of the induction heating element N by the thermal stress can be prevented.

In a case as shown in FIG. 10(F), there are formed four grooves 140 similarly to FIG. 10(C), but ends of the respective grooves 140 are positioned nearer to the central part. Each end has a small hole 142. In this case, similarly to the case shown in FIG. 10(E), a spacing of a slight length remains among the ends of the grooves 140. The remaining length of the spacing is set such that the induction heating element N does not easily crack.

Also in this case, a current flowing into the central part of the discoid induction heating element N and a current outflowing therefrom are balanced out. As a result, the induction heating element N is electrically divided into four blocks, i.e., right blocks and left blocks, with the grooves 140 serving as boundaries. Thus, eddy currents independently flow in directions shown by arrows 146 in the respective four blocks. Accordingly, the eddy currents flow not only near the edge of the induction heating element N but also near the central part thereof.

Since an eddy current flows near the central part of the induction heating element N, a heat generation distribution can be dispersed in the planar direction. Thus, an in-plane temperature uniformity of the semiconductor wafer W can be improved. Due to the provision of the small hole 142 on the end of each groove 140, concentration of a thermal stress can be alleviated. Thus, cracking of the induction heating element N by the thermal stress can be prevented. Note that, in FIGS. 10(E) and 10(F), the number of the grooves 140 extending near the central part is naturally not limited to the above numerical value.

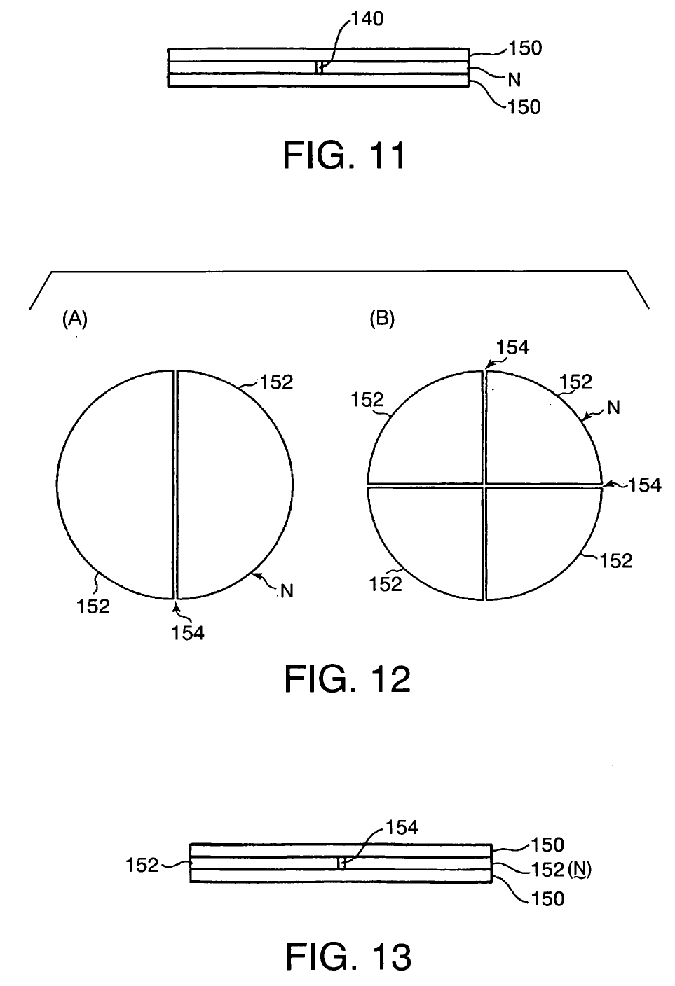

In the induction heating element shown in FIG. 10(A) and even in the induction heating elements shown in FIGS. 10(B) to 10(F) which have the groove(s) 140, a non-uniform heat generation distribution in the planar direction is inevitably more or less generated. Thus, as shown in FIG. 11, it is preferable that soaking plates are joined to the induction heating element N. FIG. 11 is a side view of the induction heating element to which soaking plates are joined.

As shown in FIG. 11, thin soaking plates 150 are joined to the upper surface and the lower surface of the induction heating element N. The joining method may be a heat sealing or the like. In this case, it is not necessary to dispose the soaking plates 150 on the both surfaces of the induction heating element N. The soaking plate 150 is disposed, at least, on one surface of the induction heating element N, the surface being on a side closer to (opposed to) the semiconductor wafer W. Thus, a heat generated on the induction heating element N is conducted to the soaking plate 150 to thereby disperse a heat generation distribution in the planar direction. Thus, the semiconductor wafer W can be heated under a uniform temperature condition. Namely, by joining the soaking plate 150, an in-plane temperature uniformity of the semiconductor wafer W can be further improved.

In this case, in order to prevent generation of an eddy current on the soaking plate 150, a material condition of the soaking plate 150 is as follows. The soaking plate 150 is made of a material having a lower electrical conductivity (higher insulating property) and a higher thermal conductivity. Specifically, the material has an electrical conductivity lower than an electrical conductivity of the induction heating element N, and a thermal conductivity higher than a thermal conductivity of the induction heating element N.

As a material of such a soaking plate 150, there may be used Si, AlN (aluminum nitride), Al₂O₃ (alumina), SiC (silicon carbide), graphite (crystalline), and the like. In this case, a non-electrically conductive ceramic material having an excellent thermal conductivity is preferred. In particular, an electrical conductivity of SiC as a ceramic material can be greatly controlled by changing contents of carbon (C).

In the structures of the induction heating element N described with referent to FIGS. 10(B) to 10(F), the single groove 140 or the plurality of grooves 140 are formed. However, not limited thereto, the induction heating element N may be divided into a plurality of pieces. FIG. 12 is a plan view showing the induction heating element divided into a plurality of pieces. FIG. 12(A) shows the induction heating element N that is divided into a pair of right and left semicircular pieces 152, with a divided clearance 154 being formed between the pieces 152. FIG. 12(B) shows the induction heating element N that is divided into four sector pieces 152, with a crisscrossing divided clearance 154 being formed among the pieces 152.

In this case, since the respective pieces 152 are electrically separated from each other, an effect similar to the effects shown in FIGS. 10(E) and 10(F) can be produced. The number of the divided pieces 152 is not particularly limited. In addition, neither a shape nor a size of each piece 12 is particularly limited. When the induction heating element N is divided into the plurality of pieces 152, a soaking plate 150, which is the same as the soaking plate described with reference to FIG. 11, is joined to one or both surface(s) of the respective pieces 152 so as to integrate these pieces 152.

<Evaluation of Induction Heating Element with Groove>

Heat generation distributions when the induction heating elements N having the groove(s) 140 shown in FIGS. 10(B) to 10(D) were experimented by simulation. The evaluation result is described below. In addition, the induction heating element N that does not have a groove as shown in FIG. 10(A) was evaluated as a reference. Similarly to the case described with reference to FIG. 10, an SiC disc having a diameter of 350 mm was used as the induction heating element N. An electrical conductivity of the SiC disc was set at 1000 (S/m), and the same induction current was flown through the coil part.

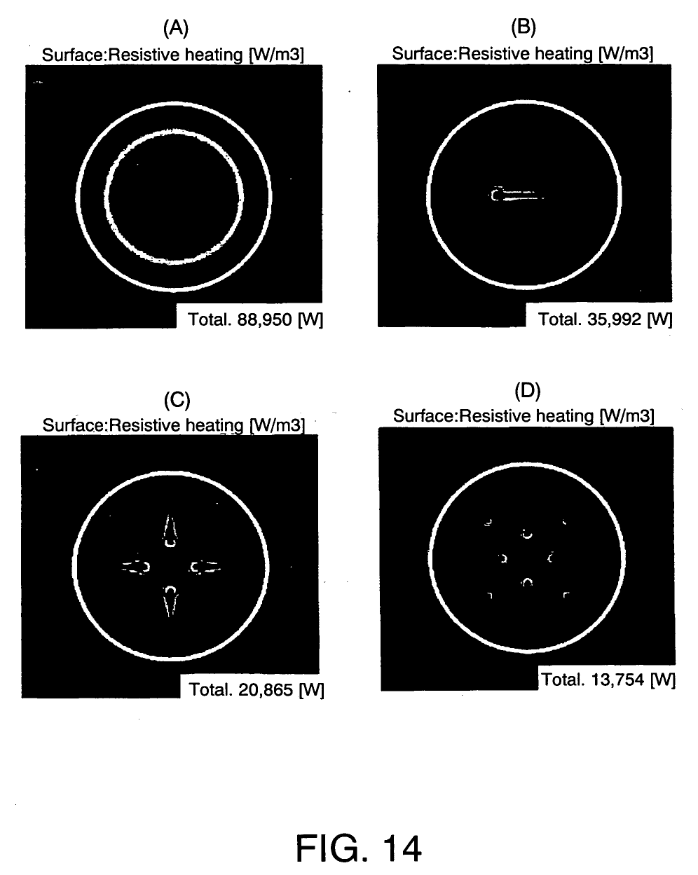

FIG. 14 is a view showing a simulation result of induction heating by the induction heating element. FIG. 14(A) corresponding to FIG. 10(A) shows an induction heating element that does not have a groove. FIG. 14(B) corresponding to FIG. 10(B) shows an induction heating element having one groove. FIG. 14(C) corresponding to FIG. 10(C) shows an induction heating element having four grooves. FIG. 14(D) corresponding to FIG. 10(D) shows an induction heating element having eight grooves. In the respective drawings, an outer circumferential white line depicts a coil. The brighter (whiter) the portion in the induction heating element is, the higher the temperature of the portion is.

In the induction heating element that does not have a groove as shown in FIG. 14(A), the edge (peripheral part) of the induction heating element had a significantly higher temperature by a skin effect, but the temperature was drastically lowered as the measuring point came closer to the central part. Thus, it can be understood that a difference in the heat generation distribution was considerably large. A total heat generation amount at this time was 88980 [W].

On the other hand, in the induction heating element having one groove as shown in FIG. 14(B), the edge, the opposed sides of the groove, and the surrounding portions of the small holes had prominently high temperatures by a heat generation. Thus, as compared with the case in FIG. 14(A), it can be understood that the heat generation distribution was somewhat dispersed so that the heat generation distribution was uniformized. A total heat generation amount at this time was 35992 [W].

In the induction heating element having four grooves as shown in FIG. 14(C), the edge, the opposed sides of the groove, and the surrounding portions of the small holes had prominently high temperatures by a heat generation, similarly to FIG. 14((B). Thus, as compared with the case in FIG. 14(B), it can be understood that the heat generation distribution was further dispersed so that the heat generation distribution was further uniformized. A total heat generation amount at this time was 20865 [W].

In the induction heating element having eight grooves as shown in FIG. 14(D), the edge, the opposed sides of the groove, and the surrounding portions of the small holes had prominently high temperatures by a heat generation, similarly to FIGS. 14(B) and 14(C). Thus, as compared with the case in FIG. 14(C), it can be understood that the heat generation distribution was still further dispersed so that the heat generation distribution was still further uniformized. A total heat generation amount at this time was 13754 [W].

Thus, it can be understood that, as the number of the grooves is increased, the heat generation distribution can be more dispersed in the planar direction so as to uniformize the temperature distribution. In this case, as the heat generation distribution is more dispersed, the total heat generation amount is gradually lowered. Thus, the number of the grooves may be optimized in consideration of the effect of the heat generation and the degree of uniformity of the heat generation distribution.

In the experiment, the electrical conductivity of the SiC disc was 1000 [S/m]. Meanwhile, SiC discs having an electrical conductivity of 200 [S/m] and SiC disc having an electrical conductivity of 2000 [S/m] were simulated in the same manner as above. The simulation results were similar to the result as described above. Thus, it can be understood that an induction heating element having an electrical conductivity of at least from 200 [S/m] to 2000 [S/m] is preferably used.

### Second Embodiment of Processing Apparatus

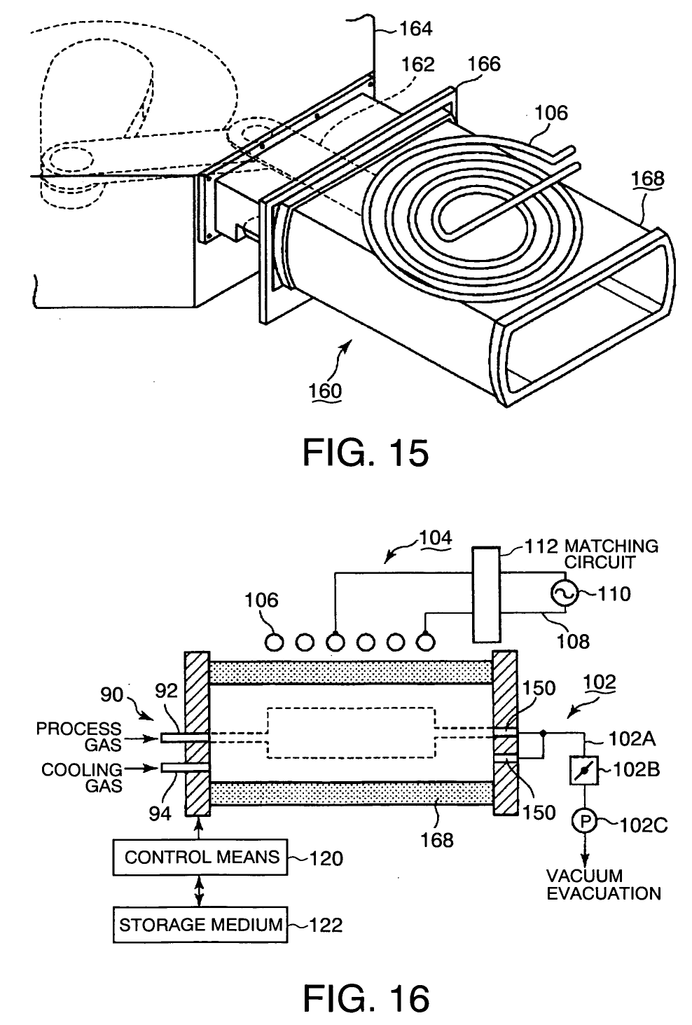

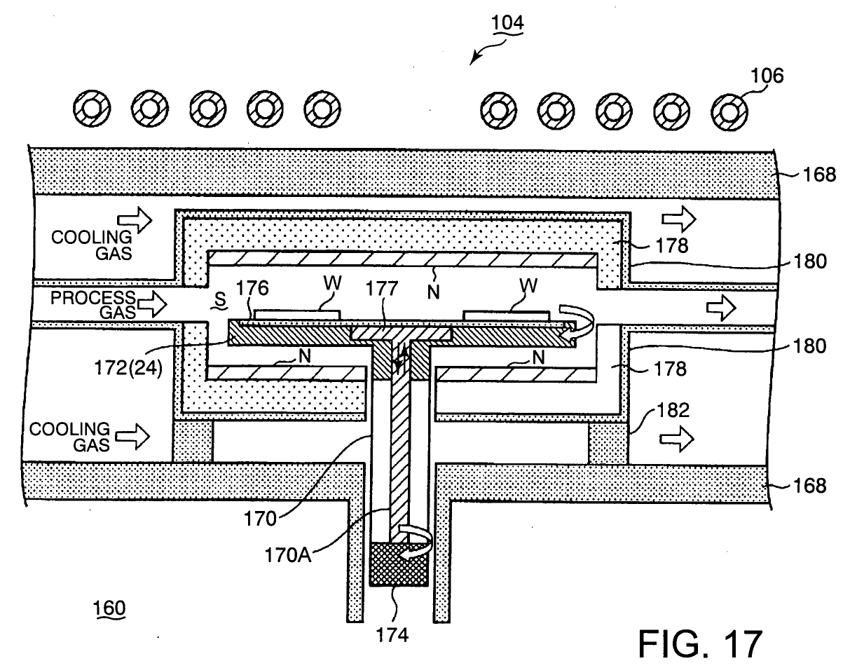

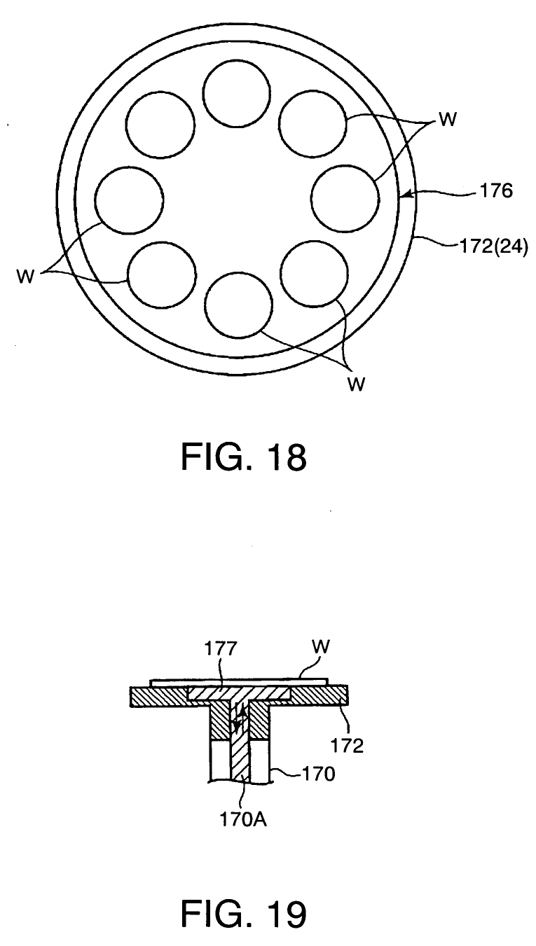

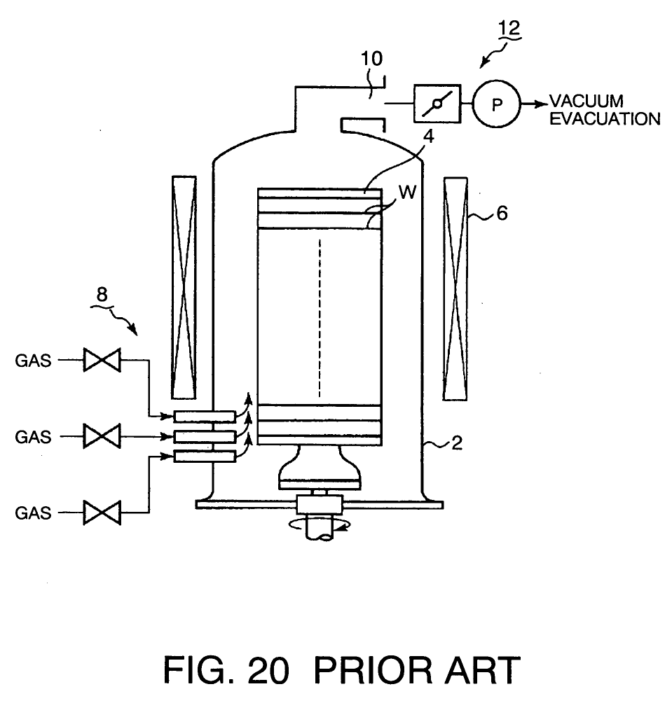

Next, a processing apparatus in a second embodiment of the present invention is described below. FIG. 15 is a perspective view showing a processing apparatus in a second embodiment of the present invention. FIG. 16 is a schematic view showing an appearance of the processing apparatus in the second embodiment. FIG. 17 is an enlarged structural view showing the processing apparatus in the second embodiment. FIG. 18 is a plan view showing a placing table as a holding part for an object to be processed. The identical parts and components are represented by the same reference numbers as those of the above embodiment, and detailed description thereof is omitted.

As shown in FIGS. 15 to 17, a processing apparatus 160 is connected to a transfer chamber 164 having a transfer arm mechanism 162 via a gate valve 166. The transfer chamber 164 has a reduced-pressure atmosphere, and other processing apparatuses, not shown, are connected in a cluster manner around the transfer chamber 164. By rotating and expanding or contracting the transfer arm mechanism 162, a semiconductor wafer W can be transferred between the transfer chamber 164 and the processing apparatus 160 via the gate valve 166 which is opened. At this time, as described below, a plurality of wafers W are simultaneously transferred.

As shown in FIGS. 16 and 17, the processing apparatus 160 includes a quartz processing vessel 168 of a box-like shape through which an electromagnetic wave can pass, and a coil part for induction heating 104 outside the processing vessel 168, specifically, on an upper side of a ceiling part of the processing vessel 168. A metal pipe 106 constituting the coil part for induction heating 104 is helically formed along the ceiling surface of the processing vessel 168. Connected to the metal pipe 106 are a matching circuit 112 and a radiofrequency power source 110. Thus, a radiofrequency can be introduced into the processing vessel 168. Although not shown, a cooler is connected to the metal pipe 106.

As shown in FIG. 16, a gas supply part 90 including two gas nozzles 92 and 94 are disposed on one sidewall of the processing vessel 168, so that required gases can be supplied into the processing vessel 168, while flow rates of the gases being respectively controlled. Formed in an opposed sidewall of the processing vessel 168 is an exhaust port 150 to which an exhaust system 102 having a pressure adjusting valve 102B, an exhaust pump 102C and so on is connected.

In the processing vessel 168, there is disposed a placing table 172 serving as a holding part 24 that is rotatably supported by a rotational shaft 170. The rotational shaft 170 is rotated by a rotation driving means 174 disposed on a proximal end of the rotational shaft 170. A discoid transfer plate 176 is placed on an upper surface of the placing table 172. A plurality of, e.g., eight in the illustrated example, wafers W (see, FIG. 18) are circumferentially placed on the transfer plate 176. A diameter of the wafer W is from about 50 mm to about 500 mm, for example.

The rotational shaft 170 is of a biaxial structure. A central shaft 170A can be vertically moved, and an elevation plate 177 is disposed on an upper end of the central shaft 170A. Thus, by moving the central shaft 170A in an up and down direction, the transfer plate 176 on which the wafers W are placed can be vertically moved. By transferring the transfer plate 176, the plurality of (eight) wafers W can be transferred at the same time.

Heat insulation members 178 made of a carbon graphite whose porosity is remarkably high are disposed to surround the placing table 172 from above and below. A space between the heat insulation members 178 provides a processing space S. An overall outer circumference of the heat insulation member 178 is covered with a heat-insulation-member protective structure 180 made of, e.g., quartz. The heat-insulation-member protective structure 180 is supported in the processing vessel 168 by legs 182. A process gas such as a film deposition gas is made to flow from the one gas nozzle 92 into the processing space S that is an inside part of the heat-insulation-member protective structure 180, and a cooling gas such as a rare gas or an N₂ gas is made to flow from the other gas nozzle 94 to an outside part of the heat-insulation-member protective structure 180.

The induction heating element N as has been described above is provided to such a processing vessel 168. To be specific, a first induction heating element N is disposed on a lower surface of a ceiling part of the heat insulation member 178 surrounding the processing space S such that the first induction heating element N is opposed to an upper surface of the placing table 172. In addition, a second induction heating element N is disposed on an upper surface of a bottom part of the heat insulation member 178 such that the second induction heating element N is opposed to a lower surface of the placing table 172. In this case, it is possible to dispose only the first induction heating element N. As the induction heating element N, there is used an induction heating element which has been described with reference to FIGS. 10(A) to 10(F). The induction heating element N is joined to the heat insulation member 178 by thermal adhesion or the like.

In the case of this processing apparatus 160, a predetermined process gas is supplied with its flow rate being controlled into the processing space S while the exhaust system 102 is driven, so as to maintain an the inside of the processing space S at a predetermined pressure. Then, the semiconductor wafers W are rotated by rotating the placing table 172, and the coil part for induction heating 104 is driven. Thus, a radiofrequency is introduced into the processing vessel 168 from the metal pipe 106 constituting the coil part 104, and the induction heating element N is heated by the same principle as described above. Accordingly, the semiconductor wafers W are heated to a predetermined temperature and maintained thereat, and a predetermined process is performed under this state. Also in this case, the wafers W can be heated, with an improved in-plane uniformity temperature of the wafers W, which is similar to the case as described above.

Although the above-described embodiments are described by taking for instance a so-called batch type processing apparatus capable of simultaneously processing a plurality of semiconductor wafers W, the present invention is not limited thereto. For example, in the example of the apparatus shown in FIG. 17, the dimensions of the placing table 172 may be reduced as shown in FIG. 19 such that only one semiconductor wafer W can be placed on the central part of the placing table 172. In this case, the apparatus is a single-wafer type processing apparatus that processes wafers one by one.

In this embodiment, a film deposition process is described by way of example of a heat process. However, not limited thereto, the present invention may be applied to another heat process, such as an oxidation process, a diffusion process, a modification process, and an etching process.

In this embodiment, as a material of the induction heating element N, there are described glassy carbon and a conductive ceramic material (SiC) which are merely raised as examples. Not limited thereto, graphite or the like may be used. In addition, a conductive silicon nitride may be used as the conductive ceramic material.

In addition, a semiconductor wafer is taken as an example of an object to be processed. However, not limited thereto, the present invention may be applied to a glass substrate, an LCD substrate, a ceramic substrate, and so on.

1. A processing apparatus for subjecting an object to be processed to a heat process, the processing apparatus comprising:
a processing vessel capable of containing a object to be processed;
a coil part for induction heating that is disposed outside the processing vessel;
a radiofrequency power source configured to apply a radiofrequency power to the coil part for induction heating;
a gas supply part configured to introduce a gas into the processing vessel;
a holding part configured to hold the object to be processed in the processing vessel; and
a induction heating element that is inductively heated by a radiofrequency from the coil part for induction heating so as to heat the object to be processed;
wherein the induction heating element is provided with a cut groove for controlling a flow of an eddy current generated on the induction heating element.

2. The processing apparatus according to claim 1, wherein
the coil part for induction heating is wound around an outer circumference of the processing vessel.

3. The processing apparatus according to claim 1, wherein
the induction heating element is held by the holding part.

4. The processing apparatus according to claim 3, wherein
the holding part can be loaded into and unloaded from the processing vessel, with holding the object to be processed and the induction heating element.

5. The processing apparatus according to claim 3, wherein
the object to be processed includes a plurality of objects to be processed,
the induction heating element includes a plurality of induction heating elements, and
the holding part holds the objects to be processed and the induction heating elements such that the objects to be processed and the induction heating elements are alternately positioned.

6. The processing apparatus according to claim 1, wherein
the coil part for induction heating includes a metal pipe, and
the metal pipe is connected to a cooler that flows a coolant through the metal pipe.

7. The processing apparatus according to claim 1, wherein
the object to be processed has a discoid shape, and
the induction heating element has a discoid shape whose diameter is larger than a diameter of the object to be processed.

8. The processing apparatus according to claim 1, wherein
the object to be processed and the induction heating element can be brought close to each other.

9. The processing apparatus according to claim 1, wherein
the induction heating element has a flat shape, and
the groove is formed from an edge of the induction heating element toward a central part of the induction heating element.

10. The processing apparatus according to claim 9, wherein
the groove includes a plurality of grooves that are arranged in a circumferential direction of the induction heating element at equal intervals therebetween.

11. The processing apparatus according to claim 10, wherein
the grooves are divided into a plurality of groups depending on lengths, and
the respective grooves in the same group are arranged in the circumferential direction of the induction heating element at equal intervals therebetween.

12. The processing apparatus according to claim 1, wherein
a small hole for preventing cracking caused by a thermal stress is formed on an end of the groove.

13. A processing apparatus for subjecting an object to be processed to a heat process, the processing apparatus comprising:
a processing vessel capable of containing the object to be processed;
a coil part for induction heating that is disposed outside the processing vessel;
a radiofrequency power source configured to apply a radiofrequency power to the coil part for induction heating;
a gas supply part configured to introduce a gas into the processing vessel;
a holding part configured to hold the object to be processed in the processing vessel; and
a induction heating element that is inductively heated by a radiofrequency from the coil part for induction heating so as to heat the object to be processed;
wherein the induction heating element is divided into pieces.

14. The processing apparatus according to one of claims 1 and 13, wherein
an electrical conductivity of the induction heating element is within a range between 200 S/m and 20000 S/m.

15. The processing apparatus according to one of claims 1 and 13, wherein
a soaking plate is joined to, at least, a surface of the induction heating element, the surface being opposed to the object to be processed.

16. The processing apparatus according to claim 15, wherein
the soaking plate is made of a material having an electrical conductivity lower than an electrical conductivity of the induction heating element, and a thermal conductivity higher than a thermal conductivity of the induction heating element.

17. The processing apparatus according to claim 16, wherein
the soaking plate is made of one or more materials selected from the group consisting of silicon, aluminum nitride (AlN), alumina (Al₂O₃), and SiC.

18. The processing apparatus according to one of claims 1 and 13, wherein
the induction heating element is made of one or more materials selected from the group consisting of conductive ceramic, graphite, glassy carbon, conductive quartz, and conductive silicon.

19. A processing method for subjecting an object to be processed to a heat process, the processing method comprising:
a step in which a holding part is inserted into a processing vessel, the holding part holding the object to be processed and induction heating element which is provided with a cut groove; and
a step in which a gas is introduced into the processing vessel, and the induction heating element is inductively heated by applying thereto a radiofrequency from a coil part for induction heating wound around an outer circumference of the processing vessel, whereby the object to be processed is heated so as to be thermally processed by the thus heated induction heating element;
wherein a flow of an eddy current generated on the induction heating element inductively heated is controlled by the cut groove provided in the induction heating element.

20. The processing method according to claim 19, wherein
the object to be processed includes a plurality of objects to be processed,
the induction heating element includes a plurality of induction heating elements, and
the holding part holds the objects to be processed and the induction heating elements such that the objects to be processed and the induction heating elements are alternately positioned.

21. The processing method according to claim 19, further comprising a step in which the object to be processed and the induction heating element are brought close to each other or away from each other.

22. A processing method for subjecting an object to be processed to a heat process, the processing method comprising:
a step in which the object to be processed that is held by a holding part is inserted into a processing vessel in which induction heating element which is provided with a cut groove is contained; and
a step in which a gas is introduced into the processing vessel, and the induction heating element is inductively heated by applying thereto a radiofrequency from a coil part for induction heating wound around an outer circumference of the processing vessel, whereby the object to be processed is heated so as to be thermally processed by the thus heated induction heating element;
wherein a flow of an eddy current generated on the induction heating element inductively heated is controlled by the cut groove provided in the induction heating element.
